(19) United States
(12) Patent Application Publication
(10) Pub. No.: US 2021/0279576 A1
(43) Pub. Date: Sep. 9, 2021

(54) ATTENTION NEURAL NETWORKS WITH TALKING HEADS ATTENTION

(71) Applicant: Google LLC, Mountain View, CA (US)

(72) Inventors: Noam M. Shazeer, Palo Alto, CA (US); Zhenzhong Lan, Hangzhou (CN)

(21) Appl. No.: 17/191,591

(22) Filed: Mar. 3, 2021

Related U.S. Application Data
(60) Provisional application No. 62/984,778, filed on Mar. 3, 2020.

(51) Int. Cl. G06N 3/08; G06N 3/04

(52) U.S. Cl. CPC G06N 3/08; G06N 3/04

(57) ABSTRACT

Methods, systems, and apparatus, including computer programs encoded on a computer storage medium, for performing a machine learning task on a network input to generate a network output. In one aspect, one of the systems includes an attention neural network configured to perform the machine learning task, the attention neural network including one or more attention layers, each attention layer comprising an attention sub-layer and, optionally, a feed-forward sub-layer. At least one of the attention layers includes an attention sub-layer that applies talking heads attention instead of conventional multi-head attention.

### CROSS-REFERENCE TO RELATED APPLICATION

This application claims priority to U.S. Provisional Application No. 62/984,778, filed on Mar. 3, 2020. The disclosure of the prior application is considered part of and is incorporated by reference in the disclosure of this application.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that performs a machine learning task on a network input using an attention neural network that includes attention sub-layers that apply talking heads attention.

Conventional attention neural networks employ multi-head attention, in which multiple attention “heads” independently apply the same attention mechanism to an input sequence and a set of memory vectors that can be the same as the input sequence or different from the input sequence. Because each head has different parameters from the other heads, the different heads learn to focus on different aspects of the input sequence and the memory vectors.

“Talking heads” attention refers to attention in which the attention mechanism that is applied by each “head” of the mechanism is influenced by the attention mechanism applied by the other “heads” rather than being applied independently as in conventional multi-head attention.

Particular embodiments of the subject matter described in this specification can be implemented so as to realize one or more of the following advantages.

The attention layers within some existing attention neural networks employ multi-head attention. In multi-head attention, multiple attention layers (“heads”) operate in parallel, each with different learned projections on its inputs and outputs. By using a dimensionality reduction in the input projections, the computational cost is kept similar to that of basic, i.e., single head, attention. Generally, quality is improved, presumably due to the ability to attend to multiple positions simultaneously based on multiple different types of relationships.

However, it is generally accepted, see, e.g., Vaswani, et al referenced below, that increasing the number of attention heads (with a corresponding additional reduction in the dimensionality) beyond a certain point is counterproductive and model quality degrades. One potential explanation for this is that the query-vectors and key-vectors become so low-dimensional that their dot product (or other attention function) can no longer constitute an informative matching function.

The described techniques, however, address this problem by inserting at least a learned linear projection across the attention-heads dimension of the attention-logits tensor. This allows each attention function to depend on all of the keys and queries, i.e., allows for communication between attention heads instead of complete independence. This “talking heads” attention leads to better performance, e.g., better perplexities or other measures of output quality, on a variety machine learning tasks relative to existing multi-head attention schemes (which were previously thought to be state-of-the-art). In other words, the described talking-heads attention scheme allows for additional attention heads to be added to the attention layers of an attention neural network in a way that improves rather than degrades the performance of the neural network as had been found when conventional multi-head attention has been employed.

Thus, the techniques described in this specification allow a neural network system to process input sequences, generate output sequences, or both more accurately than existing attention-based networks that use conventional multi-head attention.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for applying a talking heads attention mechanism.

FIG. 3 is a flow diagram of an example process for computing transformed attention weights.

Like reference numbers and designations in the various drawings indicate like elements.

### DETAILED DESCRIPTION

This specification describes a system implemented as computer programs on one or more computers in one or more locations that performs a machine learning task on a network input to generate a network output for the machine learning task.

The machine learning task can be any machine learning task that (i) operates on a network input that is an input sequence, (ii) generates a network output that is an output sequence, or (iii) both.

Some examples of machine learning tasks that the system can be configured to perform follow.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language—target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task, where the input is a conditioning input and the output is a sequence of intensity value inputs for the pixels of an image.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

To perform the machine learning task, the system includes an attention neural network that includes multiple attention layers. Each layer operates on a respective input sequence that includes a respective layer input at each of one or more positions.

Moreover, each of the layers includes an attention sub-layer and, optionally, a feed-forward sub-layer. The attention sub-layer receives the input sequence for the layer and applies an attention mechanism on the input sequence for the layer to generate an attended input sequence. The attention mechanism applied by the attention layer depends on the configuration of the attention neural network, as will be described in more detail below, however, at least one of the attention layers applies an attention mechanism that uses “talking heads” attention. When included, the feed-forward sub-layer then operates on the attended input sequence to generate an output sequence for the layer. When no feed-forward sub-layer is included, the attended input sequence is the output sequence for the layer.

Generally, the layers within the attention neural network can be arranged in any of a variety of configurations.

As one example, when the network input is an input sequence, the attention neural network includes an encoder neural network that includes a subset of the plurality of layers and that encodes the input sequence to generate a respective encoded representation of each input in the sequence. In this example, the attention mechanism applied by the layers in the encoder is a self-attention mechanism.

As another example, the attention neural network includes a decoder neural network that includes a different subset of the plurality of layers and that processes either the network input or the encoded representation of the network input to generate the network output. In some of these examples, when the network output is an output sequence the decoder neural network operates auto-regressively and the attention sub-layers within some or all of the layers of the decoder apply masked self-attention over the partially generated output sequence. When the neural network includes both an encoder and a decoder, some of the layers in the decoder apply cross-attention into the encoded representations while others apply self-attention over the output sequence, either masked or not masked. When the attention neural network includes a decoder neural network that operates directly on the input sequence, the attention layers within the decoder can apply a self-attention mechanism over the input sequence.

The specifics of the operation of the attention layers within the decoder neural network and the encoder neural network are described in more detail in Vaswani, et al, attention Is All You Need, arXiv:1706.03762, and Raffel, et al, Exploring the Limits of Transfer Learning with a Unified Text-to-Text Transformer, arXiv:1910.10683, and Devlin et al, BERT: Pre-training of Deep Bidirectional Transformers for Language Understanding, arXiv:1810.04805, the entire contents of which are hereby incorporated by reference herein in their entirety.

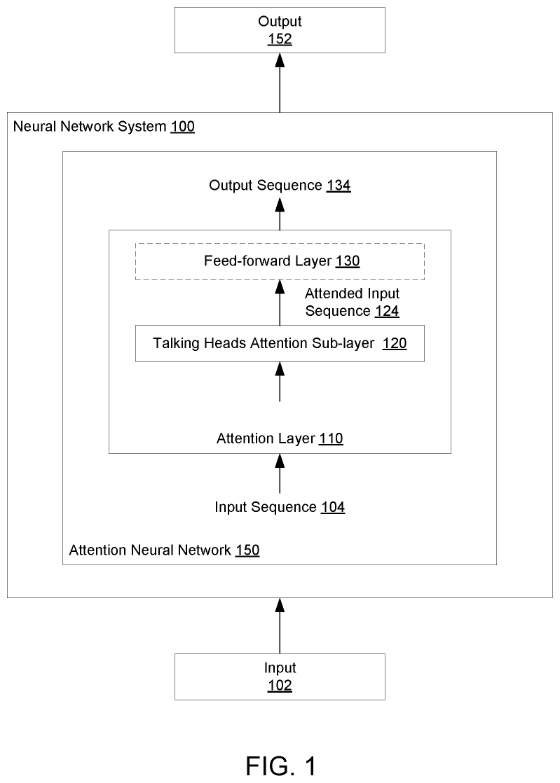

FIG. 1 shows an example neural network system 100. The neural network system 100 is an example of a system implemented as computer programs on one or more computers in one or more locations, in which the systems, components, and techniques described below can be implemented.

The neural network system 100 can receive an input 102 and perform a machine learning task on the input 102 to generate an output 152.

As described above, the neural network system 100 can perform any of a variety of tasks that involves (i) operating on an input 102 that is an input sequence, (ii) generating an output 152 that is an output sequence, or (iii) both.

The neural network system 100 includes an attention neural network 150 that includes multiple attention layers 110.

Each attention layer 110 operates on an input sequence 104 and generates a corresponding output sequence 134.

Although one attention layer is depicted in FIG. 1 for convenience, as described above, the attention neural network 150 generally includes many other layers, including other attention layers and, for example, embedding layers and an output layer.

Specifically, the input sequence 104 has a respective input at each of one or more input positions in an input order and the output sequence 134 has a respective output at each of one or more output positions in an output order. That is, the input sequence 102 has one or more inputs arranged according to an input order and the output sequence 134 has one or more outputs arranged according to an output order.

In general, the input sequence 104 can be any intermediate sequential data generated by the attention neural network 150 when performing the machine learning task on the input 102. For example, the input sequence 104 can be embedded (i.e., numeric) representations of the system input 102 generated by an embedding layer. As another example, the input sequence 104 can be an output sequence generated by a preceding attention layer or other layer in the attention neural network 150. As another example, when the neural network 150 generates the network output auto-regressively, the input sequence 140 can be embedded representations of the currently generated network output as of the current time step.

To generate the output sequence 134 from the input sequence 104, each attention layer 110 includes an attention sub-layer 120 and, optionally, a feed-forward sub-layer 130.

The attention sub-layer 120 receives the input sequence 104 for the layer 110 and applies an attention mechanism on the input sequence for the layer to generate an attended input sequence 124.

Generally, to apply the attention mechanism, the sub-layer 120 applies talking heads attention, i.e., instead of using conventional multi-head attention.

In conventional multi-head attention, each of multiple attention heads generates a set of queries from the input sequence for the layer and a set of keys and a set of values from a set of memory vectors for the layer, and then applies an attention function using the queries, keys, and values to generate an output of the attention head. The attention function can be any appropriate variant of a query-key-value (QKA) attention function, e.g., a dot product attention function or a scaled dot product attention function. The sub-layer 120 then combines the outputs of the multiple attention heads, e.g., by concatenating the outputs and, optionally, processing the concatenated outputs through a linear layer.

Examples of QKV attention are described in Vaswani, et al, Attention Is All You Need, arXiv:1706.03762, Raffel, et al, Exploring the Limits of Transfer Learning with a Unified Text-to-Text Transformer, arXiv:1910.10683, Devlin et al, BERT: Pre-training of Deep Bidirectional Transformers for Language Understanding, arXiv:1810.04805, Dai, et al, Transformer-XL: Attentive Language Models Beyond a Fixed-Length Context, arXiv:1901.02860, and Kitaev, et al, Reformer: The Efficient Transformer, arXiv: 2001.04451, the entire contents of which are hereby incorporated by reference herein in their entirety.

Generally, in conventional multi-head attention, each attention head generates the output independently from each other attention head. That is, the generation of the queries, keys and values and the generation of the output of the attention head from the queries, keys, and values is performed independently for each head.

In talking heads attention, the attention mechanism also generates multiple sets of queries from the input sequence for the layer and multiple sets of keys and values from the memory vectors for the layer. However, unlike in multi-head attention, the attention mechanism then generates respective outputs for each set of values in a manner that is dependent on the processing that is performed to generate the outputs for the other sets of values.

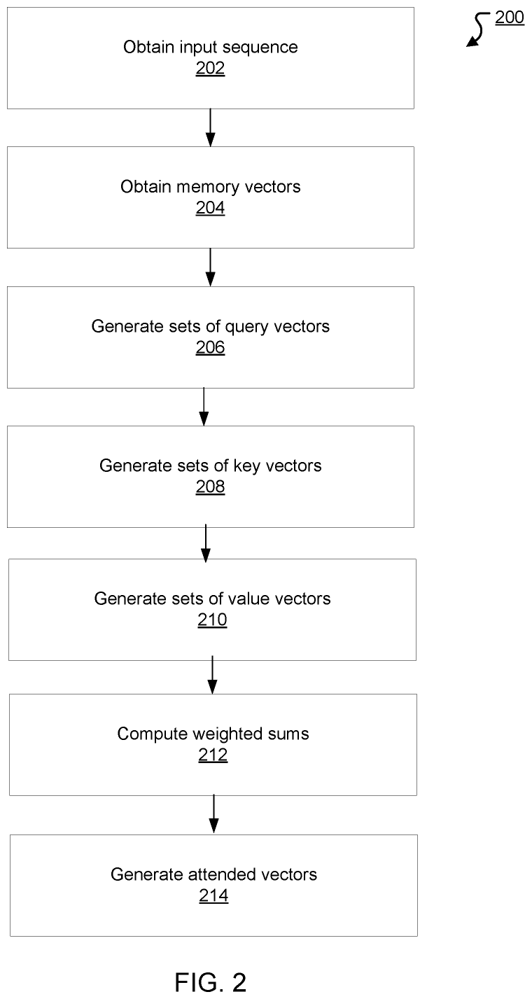

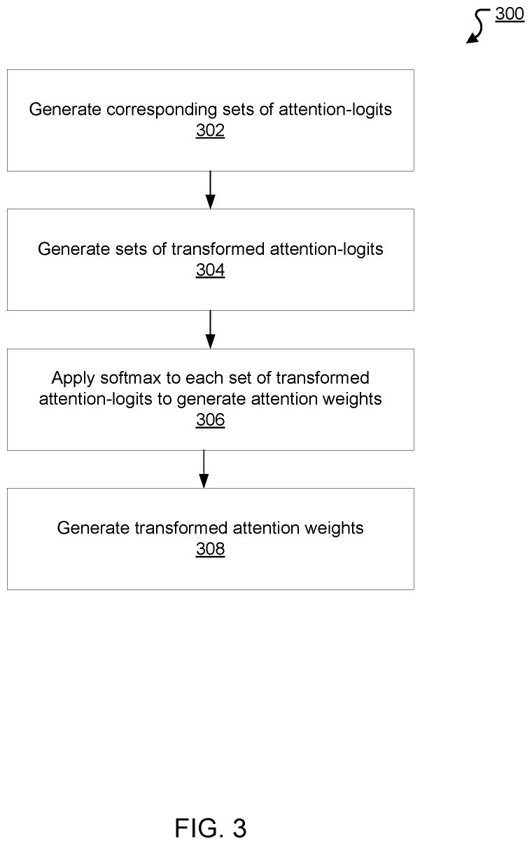

Applying talking heads attention is described in more detail below with reference to FIGS. 2 and 3.

As described above, the neural network generally includes multiple attention layers. All of the attention layers can apply talking heads attention or some attention layers can apply talking heads attention while other attention layers can apply conventional multi-head or single-head attention. Generally, an attention layer that applies talking heads attention can be inserted in place of any conventional attention layer in any attention neural network architecture, e.g., in any of the neural networks described in Vaswani, et al, Attention Is All You Need, arXiv:1706.03762, Raffel, et al, Exploring the Limits of Transfer Learning with a Unified Text-to-Text Transformer, arXiv:1910.10683, Devlin et al, BERT: Pre-training of Deep Bidirectional Transformers for Language Understanding, arXiv:1810.04805, Dai, et al, Transformer-XL: Attentive Language Models Beyond a Fixed-Length Context, arXiv:1901.02860, and Kitaev, et al, Reformer: The Efficient Transformer, arXiv: 2001.04451, the entire contents of which are hereby incorporated by reference herein in their entirety.

In some cases, the attended input sequence 124 is the final output of the attention mechanism. In some other cases, the sub-layer 120 applies one or more other operations, e.g., residual connections, layer normalization, or both, to the final output to generate the sequence 124.

When included, the feed-forward sub-layer 130 then operates on the attended input sequence 124 to generate an output sequence 134 for the layer 110, e.g., by processing each attended input through a fully-connected neural network and then, optionally, applying layer normalization, a residual connection, or both to the output of the fully-connected neural network. As a particular example, the fully-connected neural network can apply, to each attended input in parallel, one linear transformation, followed by an activation function, e.g., a non-linear elementwise activation function, e.g., a ReLU activation function, and then followed by another linear transformation.

When the feed-forward sub-layer 130 is not included, the attended input sequence 124 is the output sequence 134 for the layer.

Generally, the layers within the attention neural network can be arranged in any of a variety of configurations and the attention mechanism applied by the attention sub-layer 120 depends on the configuration of the attention neural network 150.

As one example, when the network input is an input sequence, the attention neural network 150 includes an encoder neural network that includes a subset of the plurality of layers and that encodes the input sequence to generate a respective encoded representation of each input in the sequence. In this example, the attention mechanism applied by the attention sub-layers 120 in the encoder is a self-attention mechanism, where the queries, keys, and values are all generated from the input sequence to the attention sub-layer, i.e., the set of memory vectors is the same as the input sequence to the layer.

As another example, the attention neural network 150 includes a decoder neural network that includes a different subset of the plurality of layers and that processes either the network input or the encoded representation of the network input to generate the network output. In some of these examples, when the network output is an output sequence, the decoder neural network operates auto-regressively and the attention sub-layers 120 within some or all of the layers of the decoder apply masked self-attention over the partially generated output sequence, where the queries, keys, and values are all generated from the input sequence to the attention sub-layer 120, i.e., the set of memory vectors is the same as the input sequence to the layer. That is, the attention function applied by the attention-sub layer is a masked attention function. A masked attention function is one that does not allow any particular position in the input sequence for the layer to attend over any position that is after the particular position in the input sequence.

When the neural network 150 includes both an encoder and a decoder, some of the layers in the decoder apply cross-attention into the encoded representations while others apply self-attention over the output sequence, either masked or not masked. In cross-attention, the queries are generated from the input sequence to the attention sub-layer 120 while the keys and values are generated from the encoded representations of the network input, i.e., the memory vectors are the encoded representations of the network input.

When the attention neural network 150 includes a decoder neural network that operates directly on the input sequence, the attention sub-layers 120 within the decoder can apply a self-attention mechanism over the input sequence.

As used in this specification, the term “learned” means that an operation or a value has been adjusted during the training of the attention neural network 150.

FIG. 2 is a flow diagram of an example process 300 for applying a talking heads attention mechanism. For convenience, the process 200 will be described as being performed by a system of one or more computers located in one or more locations. For example, a neural network system, e.g., neural network system 100 of FIG. 1, appropriately programmed in accordance with this specification, can perform the process 200.

The system obtains an input sequence for the attention layer (step 202). The input sequence includes a respective input vector at each of n positions, where n is an integer greater than or equal to one. For example, the input sequence can be an embedded representation of the network input, an embedded representation of the already generated portion of the network output, or the output sequence generated by the preceding layer in the neural network, depending on the configuration of the neural network and the position of the attention layer within the neural network.

The system obtains m memory vectors, where m is an integer that is greater than or equal to one and can have the same value as n or a different value, depending on the type of attention applied by the attention layer (step 204). When the attention layer applies self-attention, the memory vectors are the same as the input sequence. When the attention layer applies cross-attention, the memory vectors are the encoded representations of the network input.

The system applies a plurality of query linear transformations to the input vectors to generate hₖ sets of query vectors (step 206), where hₖ is an integer greater than one.

That is, for each of a fixed number hₖ of query linear transformations, the system applies the query linear transformation to the input vectors to generate a set of query vectors. Each query linear transformation generally involves multiplying each input vector by a learned weight matrix and, optionally, adding a learned bias to generate a set of query vectors. Each query vector in each set corresponds to a respective one of the input vectors, i.e., each set includes the same number n of query vectors as there are input vectors in the input sequence.

The system applies hₖ key linear transformations to the memory vectors to generate a corresponding set of key vectors for each of the hₖ sets of query vectors (step 208). That is, for each of a fixed number hₖ of key linear transformations, the system applies the key linear transformation to the input vectors to generate a set of key vectors. Each key vector in each set corresponds to a respective one of the memory vectors, i.e., each set includes the same number m of key vectors as there are memory vectors. The number hₖ of key linear transformations is generally equal to the number hₖ of query linear transformations so that there is a corresponding set of query vectors for each set of key vectors. Each key linear transformation generally involves multiplying each input vector by a learned weight matrix and, optionally, adding a learned bias to generate a set of key vectors.

The system applies hᵥ value linear transformations to the memory vectors to generate hᵥ sets of value vectors (step 210), where hᵥ is an integer greater than one. That is, for each of a fixed number hᵥ of value linear transformations, the system applies the value linear transformation to the input vectors to generate a set of query vectors. Each value vector in each set corresponds to a respective one of the memory vectors, i.e., each set includes the same number m of value vectors as there are memory vectors. The number hᵥ of value linear transformations can be the same as the number hₖ of query and key linear transformations or can be different from the number hₖ of query and key linear transformations. Each value linear transformation generally involves multiplying each input vector by a learned weight matrix and, optionally, adding a learned bias to generate a set of value vectors.

For each input vector and each set of value vectors, the system computes a weighted sum of the value vectors in the set to generate a respective weighted value vector corresponding to the input vector (step 212). Thus, the system generates hᵥ weight value vectors for each input vector. In each weighted sum, the value vectors are weighted by a corresponding set of transformed attention weights. In particular, for each set of weight vectors the system generates a corresponding set of transformed attention weights. Each set of transformed attention weights has, for each input vector (or, analogously, for each query) a respective transformed attention weight for each of the m value vectors in the corresponding set of value vectors. The system then computes, for a given input vector and a given set of value vectors, a weighted sum of the vectors in the set of value vectors, with each value vector weighted by the transformed attention weight assigned to the value vector—input vector combination in the corresponding set of transformed attention weights.

Unlike in conventional multi-head attention, in which the final attention weights for each “head”, i.e., for each set of value vectors, are generated from a single set of queries and keys, each set of transformed attention weights depends on all of the sets of queries and all of the sets of keys. In particular, the system applies at least one learned linear transformation across the attention-head dimension as part of generating the transformed attention weights, ensuring that the transformed attention weights depend on all of the sets of queries and all of the sets of keys. Generating these transformed attention weights is described in more detail below with reference to FIG. 3.

The system generates a respective attended vector for each input vector from the hᵥ weighted value vectors for the input vector (step 214). For example, for each input vector, the system can apply an output linear transformation to a concatenation of the hᵥ weighted value vectors for the input vector to generate the respective attended vector for the input vector.

As described above, the attention layer can then perform additional operations on the attended vectors for the input sequence to generate the output sequence for the attention layer.

FIG. 3 is a flow diagram of an example process 300 for generating transformed attention weights. For convenience, the process 300 will be described as being performed by a system of one or more computers located in one or more locations. For example, a neural network system, e.g., neural network system 100 of FIG. 1, appropriately programmed in accordance with this specification, can perform the process 300.

For each query vector in each set of query vectors, the system generates a corresponding set of attention-logits for the query vector that includes a respective attention-logit for each key vector in the corresponding set of key vectors corresponding to the set of query vectors (step 302). Thus, the system generates hₖ sets of attention logits for each query that each include a respective attention-logit for each of the m key vectors. A “logit” as used in this specification is a numerical value, i.e., a score, assigned to a particular data item.

In particular, for a given query vector in a given set of query vectors, the system generates the set of attention-logits by applying an attention function between the given query vector and the set of key vectors corresponding to the given set of query vectors. The attention function can be any attention function that can be used as part of QKV attention, e.g., dot product attention or scaled dot product attention.

The system generates, from the hₖ sets of attention-logits for the query vectors in the sets of query vectors, h sets of transformed attention-logits that each include m transformed attention-logits, i.e., a respective transformed attention-logit for each memory vector (step 304). The number h of sets of transformed attention-logits is a fixed number greater than one and can be the same as or different from the number hₖ of sets of attention-logits. In particular, the system generates the h sets of transformed attention-logits by applying an attention-logit linear transformation to the hₖ sets of attention-logits. To apply the attention-logit linear transformation to the sets of attention-logits, the system, for each query-key combination, applies a learned attention-logit linear transformation weight matrix to the hₖ attention logits for the query-key combination in the hk sets of attention logits to generate h transformed attention-logits for the query-key combination. Thus, for a given query-key combination, the transformed attention-logit in any given one of the h sets is dependent on the attention-logits for the query-key combination in all hₖ sets of attention-logits. This is different from conventional multi-head attention, in which the attention-logits (that each depend on only a single set of queries and a single set of keys) would be used directly.

In some implementations, the linear transformation performed in step 304 is input-dependent. That is, in addition to the “static” linear transformation described above, the system also applies one or more “dynamic” linear transformations to the sets of attention-logits.

As a particular example, the system can apply a plurality of learned input logit linear transformations to the input vectors in the input sequence to generate a plurality of dynamic input attention-logit matrices, i.e., to generate a respective dynamic input attention-logit matrix for each query. Each dynamic input attention-logit matrix has the same dimensionality as the learned attention-logit linear transformation weight matrix.

The system can also apply a plurality of learned memory logit linear transformations to the memory vectors to generate a plurality of dynamic memory attention-logit matrices, i.e., to generate a respective dynamic memory attention-logit matrix for each query.

Then, to generate the plurality of sets of transformed attention-logits, the system applies the plurality of dynamic input attention-logit matrices to the sets of attention-logits to generate first sets of dynamic transformed attention-logits and applies the plurality of dynamic memory attention-logit matrices to the sets of attention-logits to generate second sets of dynamic transformed attention-logits (in the same manner described above for the static linear transformation). The system then computes the final sets of transformed attention-logits as a combination, e.g., sum, of the “static” sets of transformed attention-logits described above and the first and second dynamic sets. That is, the system generates each set of transformed attention-logits by, for each transformed attention-logit in the set, combining, e.g., summing, the corresponding dynamic and static transformed attention-logits from the corresponding static and dynamic sets.

The system then applies a softmax to each of the h sets of transformed attention-logits to generate a corresponding set of attention weights that includes m attention weights, i.e., a respective attention weight for each memory vector (step 306).

The system generates hᵥ sets of transformed attention weights from the h sets of attention weights by applying a learned attention weight linear transformation to the h sets of attention weights (step 308). Each set of transformed attention weights includes m transformed attention eights, i.e., a respective weight for each memory vector.

To apply the learned attention weight linear transformation, the system, for each query-key combination, applies a learned attention weight linear transformation weight matrix to the h attention weights for the query-key combination in the h sets of attention weights to generate hᵥ transformed attention weights for the query-key combination. Thus, for a given query-key combination, the transformed attention weight in any given one of the hᵥ sets is dependent on the attention weights for the query-key combination in all h sets of attention weights. This is different from conventional multi-head attention, in which the attention weights (that each depend on only a single set of queries and a single set of keys because step 304 would also not be performed) would be used directly.

In some implementations, the linear transformation performed in step 308 is input-dependent. That is, in addition to the “static” linear transformation described above, the system also applies one or more “dynamic” linear transformations to the sets of attention weights.

As a particular example, the system can apply a plurality of learned input weight linear transformations to the input vectors in the input sequence to generate a plurality of dynamic input attention weight matrices, i.e., to generate a respective dynamic input attention weight matrix for each query. Each dynamic input attention weight matrix has the same dimensionality as the learned attention weight linear transformation weight matrix.

The system can also apply a plurality of learned memory logit linear transformations to the memory vectors to generate a plurality of dynamic memory attention weight matrices, i.e., to generate a respective dynamic memory attention weight matrix for each query.

Then, to generate the plurality of sets of transformed attention weights, the system applies the plurality of dynamic input attention weight matrices to the sets of attention weights to generate first sets of dynamic transformed attention weights and applies the plurality of dynamic memory attention weight matrices to the sets of attention weights to generate second sets of dynamic transformed attention weights (in the same manner described above for the static linear transformation). The system then computes the final sets of transformed attention weights as a combination, e.g., sum, of the “static” sets of transformed attention weights described above and the first and second dynamic sets. That is, the system generates each set of transformed attention weights by, for each transformed attention weight in the set, combining the corresponding dynamic and static transformed attention weights from the corresponding static and dynamic sets.

In some cases, the system performs only one of steps 304 and 308, i.e., only applies a single linear transformation across the attention-head dimension. If the system performs only step 304, the transformed attention weights used in step 212 are equal to the attention weights computed in step 306. If the system performs only step 308, the system applies the softmax to the attention-logits instead of to the transformed attention-logits as described above.

For each attention layer in the attention neural network, the system can repeatedly perform the processes 200 and 300 to update the input sequence to the layer. By repeatedly performing the processes 200 and 300 for all of the attention layers in the attention neural network and then by processing at least part of the output sequence generated by the last attention layer in the attention neural network using one or more output layers, the system can generate a network output for a received network input.

That is, the processes 200 and 300 can be performed as part of predicting an output for an input for which the desired output, i.e., the output that should be generated by the system for the input sequence, is not known.

The processes 200 and 300 can also be performed as part of processing inputs derived from a set of training data, i.e., inputs derived from a set of inputs for which the output that should be generated by the system is known, in order to train the attention neural network to determine trained values for the parameters of the attention neural network. The system can repeatedly perform the processes 200 and 300 on inputs selected from a set of training data as part of a conventional machine learning training technique to train the attention layers and the output layer(s) of the neural network, e.g., a gradient descent with backpropagation training technique that uses a conventional optimizer, e.g., stochastic gradient descent, RMSprop, or Adam optimizer, to optimize an objective function that is appropriate for the task that the attention neural network is configured to perform. During training, the system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the attention neural network in parallel. Moreover, the system can first pre-train the neural network on a large unsupervised data set through unsupervised learning, e.g., to minimize a BERT loss or other unsupervised loss, and then fine-tune the neural network on task-specific training data to optimize the objective function for the task.

The operations performed by an example attention sub-layer that applies talking heads attention to generate an output sequence Y from an input sequence X and a set of memory vectors M are described below using Einsum notation in Table 1. In the notation of Table 1, capital letters represent tensors, e.g., matrices or other sets of vectors, followed by a dimension list in brackets. For example, a 4-dimensional tensor X with (batch, height, width, channels) dimensions would be written as X[b, h, w, c].

TABLE 1
def TalkingHeaduAttention (

| | |
|---|---|
| [symbol] [a, d_X], | # n vectors with dimensionality d_X |
| M[a, d_M], | # n vectors with dimensionality d_M |
| P_q[d_K, d_k, h_k], | # learned linear projection to produce queries |
| P_k[d_M, d_k, h_k], | # learned linear projection to produce keys |
| P_v[d_M, d_v, h_v], | # learned linear projection to produce values |
| P_o[d_ [symbol] , d_v, h_v], | # learned linear projection of output |
| P_l[b,k, h] , | # talking-heads projection for logits |
| P_v[b, d_v,]): | # talking-heads projection for [symbol] eights |

| | | |
|---|---|---|
| U[ [symbol] , d_k, h_k] = [symbol] insus(X [ [symbol] , d_X], P_q[4_X, 4_k, b_k]) | # queries | n [symbol] d_X [symbol] d_k [symbol] h_k |
| K[ [symbol] , d_k, h_k] = [symbol] insus(M [ [symbol] , d_M], P_k[d_M, d_k, b_k]) | # keys | n [symbol] d_M [symbol] d_k [symbol] h_k |
| V[ [symbol] , d_v, h_v] = [symbol] insus(M [ [symbol] , d_M], P_v[d_M, d_v, b_v]) | # values | n [symbol] d_M [symbol] d_v [symbol] h_v |
| J[ [symbol] , [symbol] , h_k] = [symbol] insus(Q [ [symbol] , 4_K], h_k], K[n, d_k, h_k]) | # d [symbol] [symbol] prod. | n [symbol] m [symbol] d_k [symbol] b_k |

| L[ [symbol] , [symbol] , h] = [symbol] insus(J [ [symbol] , m, h_K], P_l[ [symbol] _k, h]) | # Talking-heads proj. | n [symbol] m [symbol] h [symbol] h_k |
|---|---|---|
| W[ [symbol] , [symbol] , h] = softmax(L [ [symbol] , m, h], reduced_dim [symbol] n) | # Attention weights | |
| [symbol] [ [symbol] , m, h_v] = [symbol] insus(V [ [symbol] , s, h], P_v[h, h_v]) | # Talking-heads proj. | n [symbol] , [symbol] h [symbol] b_v |

| | | |
|---|---|---|
| [symbol] [ [symbol] , d_v, h_v] = [symbol] insus(U [n, m, h_v], V[m, d_v, h_v]) | # | n [symbol] m [symbol] d_v [symbol] b_v |
| Y[n, d_Y] = [symbol] insus(O[n, d_v, h_v], P_ [symbol] [d_Y, d_v, b_v]) | # | n [symbol] d_Y [symbol] d_v [symbol] h_v |

return Y[n, 4_Y] [symbol]
indicates data missing or illegible when filed

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system for performing a machine learning task on a network input to generate a network output, the system comprising one or more computers and one or more storage devices storing instructions that, when executed by the one or more computers, cause the one or more computers to implement:
an attention neural network configured to perform the machine learning task, the attention neural network comprising a plurality of layers, each layer comprising an attention sub-layer, the attention sub-layer configured to perform operations comprising:
obtaining an input sequence for the layer comprising a respective input vector at each of one or more positions;
obtaining one or more memory vectors;
applying a plurality of query linear transformations to the input vectors to generate a plurality of sets of query vectors;
applying a plurality of key linear transformations to the memory vectors to generate a corresponding set of key vectors for each set of query vectors;
applying a plurality of value linear transformations to the memory vectors to generate a plurality of sets of value vectors;
for each query vector in each set of query vectors, generating a corresponding set of attention-logits for the query vector that includes a respective attention-logit for each key vector in the corresponding set of key vectors for the set of query vectors, comprising applying an attention function between the query vector and the set of key vectors corresponding to the set of query vectors;
generating, for each input vector and for each set of value vectors, a corresponding set of transformed attention weights that includes a respective transformed attention weight for each value vector in the set of value vectors, comprising applying an attention-logit linear transformation to the sets of attention-logits for the query vectors in the sets of query vectors;
for each input vector and each set of value vectors, computing a weighted sum of the value vectors in the set weighted by the corresponding set of transformed attention weights for the input vector to generate a weighted value vector; and
generating a respective attended vector for each input vector from the weighted value vectors for the input vector.

2. The system of claim 1, wherein generating a respective attended vector for each input vector comprises:
applying an output linear transformation to a concatenation of the weighted value vectors for the input vector to generate the respective attended vector for the input vector.

3. The system of claim 1, wherein the attention sub-layer is a self-attention sub-layer and wherein the one or more input vectors are the same as the one or more memory vectors.

4. The system of claim 3, wherein the attention sub-layer is a masked self-attention sub-layer and wherein the attention function is masked.

5. The system of claim 1, wherein generating, for each input vector and for each set of value vectors, a corresponding set of transformed attention weights comprises:
generating, from the sets of attention-logits for the query vectors in the sets of query vectors, a plurality of sets of transformed attention-logits that each include a respective transformed attention-logit for each memory vector, comprising applying the attention-logit linear transformation to the sets of attention-logits; and
for each of the sets of transformed attention-logits, generating a corresponding set of attention weights that includes a respective attention weight for each memory vector.

6. The system of claim 5, wherein the attention-logit linear transformation is learned during the training of the attention neural network.

7. The system of claim 6, the operations further comprising:
applying a plurality of learned input logit linear transformations to the input vectors to generate a plurality of dynamic input attention-logit matrices, and
applying a plurality of learned memory logit linear transformations to the memory vectors to generate a plurality of dynamic memory attention-logit matrices, and wherein generating the plurality of sets of transformed attention-logits that each include a respective transformed attention-logit for each memory vector further comprises:
applying the plurality of dynamic input attention-logit matrices to the sets of attention-logits, and
applying the plurality of dynamic memory attention-logit matrices to the sets of attention-logits.

8. The system of claim 5, wherein generating, for each input vector and for each set of value vectors, a corresponding set of transformed attention weights in the set of value vectors further comprises:
generating the sets of transformed attention weights from the sets of attention weights, comprising applying an attention weight linear transformation to the sets of attention weights to generate the sets of transformed attention weights.

9. The system of claim 8, wherein the attention weight linear transformation is learned during the training of the attention neural network.

10. The system of claim 9, the operations further comprising:
applying a plurality of learned input attention weight linear transformations to the input vectors to generate a plurality of dynamic input attention weight matrices, and
applying a plurality of learned memory attention weight linear transformations to the memory vectors to generate a plurality of dynamic memory attention weight matrices, and wherein generating the plurality of sets of transformed attention weights comprises:
applying the plurality of dynamic input attention weight matrices to the sets of attention weights, and
applying the plurality of dynamic memory attention weight matrices to the sets of attention weights.

11. The system of claim 5, wherein for each of the sets of transformed attention-logits, generating a corresponding set of attention weights that includes a respective attention weight for each memory vector comprises:
for each of the sets of transformed attention-logits, applying a softmax function to the transformed attention-logits in the set to generate the corresponding set of attention weights.

12. The system of claim 1, wherein the attention function is a dot-product attention function or a scaled dot-product attention function.

13. The system of claim 1, wherein the layer also comprises a feed-forward sub layer that is configured to:
receive an attended input sequence that includes the respective attended input vectors for each of the input vectors; and
generate an output sequence for the layer from the attended input sequence, the output sequence comprising a respective layer output vector at each of the one or more positions.

14. A system for performing a machine learning task on a network input to generate a network output, the system comprising one or more computers and one or more storage devices storing instructions that, when executed by the one or more computers, cause the one or more computers to implement:
an attention neural network configured to perform the machine learning task, the attention neural network comprising a plurality of layers, each layer comprising an attention sub-layer, the attention sub-layer configured to perform operations comprising:
obtaining an input sequence for the layer comprising a respective input vector at each of one or more positions;
obtaining one or more memory vectors;
applying a plurality of query linear transformations to the input vectors to generate a plurality of sets of query vectors;
applying a plurality of key linear transformations to the memory vectors to generate a corresponding set of key vectors for each set of query vectors;
applying a plurality of value linear transformations to the memory vectors to generate a plurality of sets of value vectors;
for each query vector in each set of query vectors, generating a corresponding set of attention-logits for the query vector that includes a respective attention-logit for each key vector in the corresponding set of key vectors for the set of query vectors, comprising applying an attention function between the query vector and the set of key vectors corresponding to the set of query vectors;
generating, for each input vector and for each set of value vectors, a corresponding set of transformed attention weights that includes a respective transformed attention weight for each value vector in the set of value vectors, comprising applying an attention-logit linear transformation to the sets of attention-logits for the query vectors in the sets of query vectors;
for each input vector and each set of value vectors, computing a weighted sum of the value vectors in the set weighted by the corresponding set of transformed attention weights for the input vector to generate a weighted value vector; and
generating a respective attended vector for each input vector from the weighted value vectors for the input vector.

15. One or more non-transitory computer-readable storage media storing instructions that when executed by one or more computers cause the one or more computers to implement:
an attention neural network configured to perform a machine learning task, the attention neural network comprising a plurality of layers, each layer comprising an attention sub-layer, the attention sub-layer configured to perform operations comprising:
obtaining an input sequence for the layer comprising a respective input vector at each of one or more positions;
obtaining one or more memory vectors;
applying a plurality of query linear transformations to the input vectors to generate a plurality of sets of query vectors;
applying a plurality of key linear transformations to the memory vectors to generate a corresponding set of key vectors for each set of query vectors;
applying a plurality of value linear transformations to the memory vectors to generate a plurality of sets of value vectors;
for each query vector in each set of query vectors, generating a corresponding set of attention-logits for the query vector that includes a respective attention-logit for each key vector in the corresponding set of key vectors for the set of query vectors, comprising applying an attention function between the query vector and the set of key vectors corresponding to the set of query vectors;
generating, for each input vector and for each set of value vectors, a corresponding set of transformed attention weights that includes a respective transformed attention weight for each value vector in the set of value vectors, comprising applying an attention-logit linear transformation to the sets of attention-logits for the query vectors in the sets of query vectors;
for each input vector and each set of value vectors, computing a weighted sum of the value vectors in the set weighted by the corresponding set of transformed attention weights for the input vector to generate a weighted value vector; and
generating a respective attended vector for each input vector from the weighted value vectors for the input vector.

16. A method performed by one or more computers, the method comprising:
receiving a network input; and
processing the network input using an attention neural network that is configured to perform a machine learning task on the network input to generate a network output, the attention neural network comprising a plurality of layers, each layer comprising an attention sub-layer, the attention sub-layer configured to perform operations comprising:
obtaining an input sequence for the layer comprising a respective input vector at each of one or more positions;
obtaining one or more memory vectors;
applying a plurality of query linear transformations to the input vectors to generate a plurality of sets of query vectors;
applying a plurality of key linear transformations to the memory vectors to generate a corresponding set of key vectors for each set of query vectors;
applying a plurality of value linear transformations to the memory vectors to generate a plurality of sets of value vectors;
for each query vector in each set of query vectors, generating a corresponding set of attention-logits for the query vector that includes a respective attention-logit for each key vector in the corresponding set of key vectors for the set of query vectors, comprising applying an attention function between the query vector and the set of key vectors corresponding to the set of query vectors;
generating, for each input vector and for each set of value vectors, a corresponding set of transformed attention weights that includes a respective transformed attention weight for each value vector in the set of value vectors, comprising applying an attention-logit linear transformation to the sets of attention-logits for the query vectors in the sets of query vectors;
for each input vector and each set of value vectors, computing a weighted sum of the value vectors in the set weighted by the corresponding set of transformed attention weights for the input vector to generate a weighted value vector; and
generating a respective attended vector for each input vector from the weighted value vectors for the input vector.

17. The method of claim 16, wherein generating a respective attended vector for each input vector comprises:
applying an output linear transformation to a concatenation of the weighted value vectors for the input vector to generate the respective attended vector for the input vector.

18. The method of claim 16, wherein the attention sub-layer is a self-attention sub-layer and wherein the one or more input vectors are the same as the one or more memory vectors.

19. The method of claim 16, wherein the attention sub-layer is a masked self-attention sub-layer and wherein the attention function is masked.

20. The method of claim 16, wherein generating, for each input vector and for each set of value vectors, a corresponding set of transformed attention weights comprises:
generating, from the sets of attention-logits for the query vectors in the sets of query vectors, a plurality of sets of transformed attention-logits that each include a respective transformed attention-logit for each memory vector, comprising applying the attention-logit linear transformation to the sets of attention-logits; and
for each of the sets of transformed attention-logits, generating a corresponding set of attention weights that includes a respective attention weight for each memory vector.
